(19) United States
(12) Patent Application Publication
(10) Pub. No.: US 2016/0025594 A1
(43) Pub. Date: Jan. 28, 2016

(54) METHOD TO MEASURE FRICTION LOSS IN ENGINES AND METHOD TO DETECT ENGINE DRIVING STATE

(71) Applicant: Taizo SHIMADA, (US)

(72) Inventors: Taizo SHIMADA, Yokohama-shi (JP); Koji KOREMATSU, Inagi-shi (JP); Junya TANAKA, Tokyo (JP); Mitsuo NOTOMI, Tokyo (JP); Yoji KURODA, Tokyo (JP)

(73) Assignee: Taizo SHIMADA, Kanagawa (JP)

(21) Appl. No.: 14/774,567

(22) PCT Filed: Mar. 5, 2014
(86) PCT No.: PCT/JP2014/001201

§ 371 Date: Sep. 10, 2015

(30) Foreign Application Priority Data
Mar. 12, 2013 (JP) 2013-048964
Jan. 15, 2014 (JP) 2014-005392

(51) Int. Cl. G01M 15/04; G01N 19/02

(52) U.S. Cl. CPC G01M 15/044; G01N 19/02

(57) ABSTRACT

The angular deceleration dω/dt of an output shaft after switching from a driving state, in which an engine is driven by burning fuel that is supplied by a fuel supplying device into an engine cylinder space, to a measuring state, in which deceleration is caused by suppressing the combustion of fuel in the engine cylinder space, is measured, and a friction loss in the engine is determined on the basis of the measured friction torque Tf of the engine determined by Expression Tf=It×dω/dt), where It is the moment of inertia for the entire drive system of the engine, and the friction torque correction quantity corresponding to a work correction quantity performed by post-combustion dripping generated in the engine cylinder space after switching from the driving state to the measuring state.

### TECHNICAL FIELD

The present invention relates to a method to measure a friction loss in a diesel engine, or the like, and to a method to detect an engine driving state by using the method to measure a friction loss.

### TECHNICAL BACKGROUND

Diesel engines using carbon-neutral vegetable-oil-derived fuels have already been put into practical use in recent years to prevent global warming. However, since the vegetable-oil-derived fuels are high in viscosity unless these fuels are modified, they can hardly be directly used for diesel engines. Accordingly, such fuels have been used as biodiesel fuels (BDF®) subjected to treatment aimed to reduce the viscosity of the vegetable-oil-derived fuels to that of light oils. More specifically, the biodiesel fuels (BDF®) have been produced by mixing NaOH and methanol with a vegetable oil or waste edible oil and heating, that is, by methyl esterification. Alternatively, it has been necessary to heat a vegetable oil, supply the heated oil to an engine, and heat a fuel injection pipe with steam or a heater from the outside (see, for example, Patent Document 1).

Taking into account the cost of such methyl esterification and wastewater treatment required in such treatment, it is desirable that vegetable oils could be directly supplied and used in a diesel engine (neat biofuel), without such treatment. Accordingly, the inventors of the present application conducted a fundamental study aimed to enable the direct supply of vegetable oils to diesel engines and use thereof as fuels.

### PRIOR ARTS LIST

### Patent Document

Patent Document 1: Japanese Laid-Open Patent Publication No. 2009-168002 (A)

### SUMMARY OF THE INVENTION

### Problems to be Solved by the Invention

Incidentally, in the above-mentioned study, fuel efficiency could also be investigated, but such an investigation particularly requires an accurate estimation of friction loss in the engine. A deceleration method for measuring a friction loss on the basis of the degree of deceleration at the time when the deceleration is caused by suppressing combustion inside the cylinder space is known as a comparatively simple method to measure a friction loss in an engine. However, the problem is that the combustion inside the cylinder space is difficult to stop entirely at a predetermined timing, and therefore the accurate friction loss is difficult to measure. The present invention has been created with consideration for this problem, and it is an objective of the invention to provide a method for accurately measuring a friction loss in a diesel engine, or the like, and a method to detect an engine driving state by using the method for measuring a friction loss.

### Means to Solve the Problems

The friction loss measurement method according to a first aspect of the invention is a method to measure a friction loss in an engine, the engine being equipped with a fuel supplying device that is driven by the engine and performs fuel supply into an engine cylinder space, the method including: measuring an angular deceleration (dω/dt) of an output shaft after switching from a driving state, in which the engine is driven by burning fuel supplied by the fuel supplying device into the engine cylinder space, to a measuring state, in which deceleration is caused by suppressing the combustion of fuel in the engine cylinder space, and determining a friction loss in the engine on the basis of a friction torque Tf (for example, the measured friction torque Tf in the embodiments) of the engine which is found by Expression Tf=It×dω/dt, where It is a moment of inertia for an entire drive system of the engine, and a correction torque (for example, the friction torque correction quantity ΔTf in the embodiments) corresponding to a work (for example, the work correction quantity ΔW in the embodiments) performed by post-combustion dripping generated in the engine cylinder space after switching from the driving state to the measuring state.

It is preferred that in the above-described method to measure a friction loss, the work performed by the post-combustion dripping be calculated on the basis of a surface area of a region bounded by a line indicating a relationship between a pressure and a volume of the engine cylinder space after switching from the driving state to the measuring state; a measurement result relating to the pressure corresponding to the volume of the engine cylinder space be used for a portion of the line where the post-combustion dripping has occurred (for example, the portion from a start point A to an end point B in FIG. 9 in the embodiments); and a theoretical expression (for example, Expression (6) and Expression (7) in the embodiments) indicating an adiabatic change be used for a portion of the line other than the portion of the line where the post-combustion dripping has occurred.

It is preferred that in the above-described method to measure a friction loss, switching from the driving state to the measuring state be performed by stopping the supply of fuel to the engine cylinder space performed by the fuel supplying device.

It is preferred that in the above-described method to measure a friction loss, switching from the driving state to the measuring state be performed by supplying a non-flammable gas (for example, nitrogen N₂ gas in the embodiments) into the engine cylinder space while continuing the supply of fuel to the engine cylinder space performed by the fuel supplying device.

The driving state detection method according to a second aspect of the invention is a method to detect a driving state of an engine, the engine being equipped with a fuel supplying device that is driven by the engine and performs fuel supply into an engine cylinder space, the method including: a friction loss calculation step for measuring an angular deceleration (dω/dt) of an output shaft after switching from a driving state, in which the engine is driven by burning fuel supplied by the fuel supplying device into the engine cylinder space, to a measuring state, in which deceleration is caused by suppressing the combustion of fuel in the engine cylinder space, and determining a friction loss in the engine on the basis of a friction torque Tf of the engine which is found by Expression Tf=It×dω/dt, where It is a moment of inertia for an entire drive system of the engine, and a correction torque corresponding to a work performed by post-combustion dripping generated in the engine cylinder space after switching from the driving state to the measuring state; a friction loss comparison step for comparing the calculated friction loss in the engine with a friction loss measured when the engine is driven in a normal state; and a driving state detection step for detecting the driving state of the engine on the basis of the comparison result.

### Advantageous Effects of the Invention

In a diesel engine, or the like, even when the supply of fuel to the cylinder space is stopped and the combustion is stopped, a slight amount of fuel that has penetrated to the walls forming the cylinder space is burned (post-combustion dripping), a corresponding work is performed, and the friction loss can be difficult to measure accurately. Accordingly, in the present invention, the friction loss in an engine is determined on the basis of the friction torque Tf obtained by the deceleration method and the correction torque corresponding to the work performed by the post-combustion dripping. Therefore, the accurate friction loss in the engine which takes into account the post-combustion dripping can be calculated. As a result, the performance estimation of a diesel engine can be accurately performed both when a neat biofuel is used and when the usual diesel fuel (light oil) is used.

### BRIEF DESCRIPTION OF THE DRAWINGS

FIG. 1 is a graph representing the viscosity-changing characteristic corresponding to the temperature-changing characteristic of linseed oil, which is an example of neat biofuel, and light oil.

FIG. 2 is an explanatory drawing illustrating the test bench configuration using a diesel engine.

FIG. 3 shows graphs in which values of NOx, smoke concentration, BSFC (brake specific fuel consumption), and ISFC (indicated specific fuel combustion) with respect to the engine load (%) are depicted for linseed oil and light oil.

FIG. 4 is an explanatory drawing illustrating the measurements performed by the deceleration method.

FIG. 5 is an explanatory drawing illustrating the test device configuration using the deceleration method A.

FIG. 6 is a graph representing the results obtained by determining the engine friction loss and the driving torque for fuel injection by the deceleration method A for engine loads of three types (0%, 25%, and 50%).

FIG. 7 is an explanatory drawing illustrating a test device configuration for implementing the deceleration methods B and C.

FIG. 8 shows graphs representing the measurement results obtained with the deceleration method B, FIGS. 8A and 8B are graphs representing the measurement results for the engine friction torque and fuel injection driving torque at 3000 rpm, and FIGS. 8C and 8D are graphs representing the measurement results obtained at 2400 rpm.

FIG. 9 is a graph representing the relationship between the cylinder volume and cylinder pressure.

FIG. 10 is a graph representing the relationship between the crank angle and polytropic index κ.

FIG. 11 shows graphs illustrating an example of calculation results relating to the engine revolution speed and angular deceleration of the crankshaft, FIG. 11A is a graph obtained when the angular deceleration has been calculated for every 360° (one revolution) and FIG. 11B is a graph obtained when the angular deceleration has been calculated for every 720° (two revolutions).

FIG. 12 represents explanatory drawings for explaining a calculation method for calculating a neutral point in which torsional vibrations of the shaft in the crankshaft do not occur, FIG. 12A illustrates the calculation method based on extrapolation of measurement values in two points, and FIG. 12B illustrates the calculation method based on interpolation of measurement values in two points.

FIG. 13 illustrates an engine driving state detection method using the friction loss measurement method, FIG. 13A is a block diagram illustrating the device configuration, and FIG. 13B illustrates schematically the data stored in the memory.

### DESCRIPTION OF THE EMBODIMENTS

The embodiments of the present invention will be explained hereinbelow with reference to the drawings. The contents of the investigation which has been performed by the applicant and led to the creation of the invention of the present application will be explained before the explanation of the method to measure a friction loss in an engine in accordance with the present invention (the deceleration methods C and D explained hereinbelow).

The applicant has initially investigated how to decrease the viscosity of a neat biofuel to the level of the usual diesel engine fuel (light oil) in order to use the neat biofuel in the usual diesel engine. Linseed oil has been used as neat biofuel. Properties of linseed oil and the usual diesel engine fuel are shown in Table 1. Thus, the viscosity of linseed oil is high.

TABLE 1
Characteristics of Neat Vegetable Oil and Diesel Fuel

| | Boiling | Hu MJ/ | Kinetic Viscosity | | | |
|---|---|---|---|---|---|---|
| Test Fuel | Point | kg | mm²/s | Acid Contents of Test Fuel % | | |
| Linseed Oil | 603~*¹ K | 36.90*¹ | 28.8*¹ at 313 K | α Linolenic 54.1 | Oleic 20.4 | others 25.5 |
| Diesel Fuel | 443~633 | 42.90*¹ | 2.3*¹ | | | |

*¹Measured Value in atmospheric condition

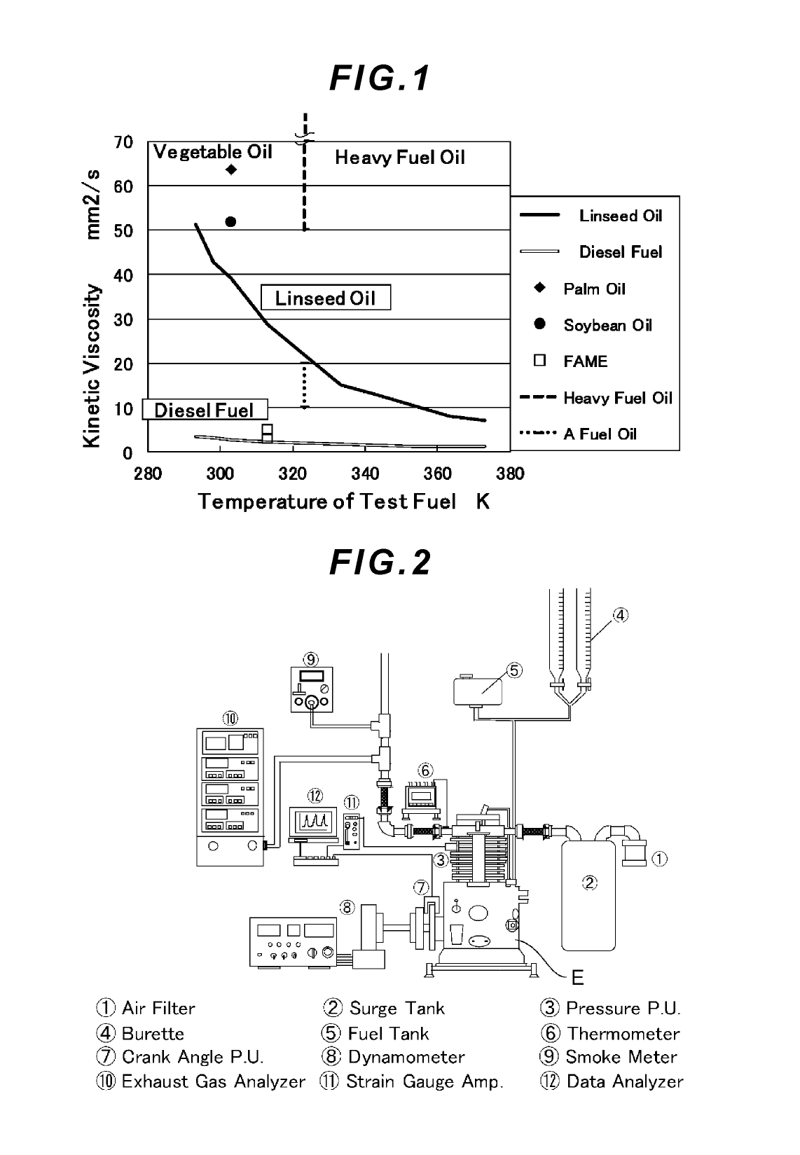

Methods based on the above-described chemical treatment can thus be used for reducing a high viscosity, but yet another method, which has been used in large diesel engines for ships, involves heating the fuel. FIG. 1 shows a viscosity-changing characteristic corresponding to the temperature-changing characteristic of linseed oil and the conventional diesel fuel. Since the above-described chemical treatment or heaters for reducing viscosity lead to cost increase, an investigation has been conducted to increase the brake specific fuel consumption BSFC by using a high-viscosity neat biofuel as is, without the methyl esterification treatment or fuel heating.

In the investigation aimed to increase the brake specific fuel consumption BSFC, a test has been conducted by using a single-cylinder air-cooled engine with the specifications shown in Table 2. The engine is provided with a fuel injection system with the specifications shown in Table 3. The maximum fuel injection pressure at the rated output is 25 MPa which is lower than in the latest automotive engines. The fuel injection start timing is fixed to 23° BTDC as a crank angle.

TABLE 2
Engine Specifications

| | |
|---|---|
| Type | Air-cooled 4 Stroke |
| | Single Cylinder |
| | D.I. Diesel Engine |
| Bore × Stroke | 82 × 78 |
| Displacement Volume | 412 cc |
| Rated Output/Engine Speed | 5.1 kW/3000 rpm |
| Mean Effective Pressure | 495 kPa |
| Max. Torque/Engine Speed | 19.6 Nm/2400 rpm |
| Mean Effective Pressure | 598 kPa |
| Compression Ratio | 21 |
| Static Injection Timing | 23° BTDC |

TABLE 3
Specifications of Fuel Injection System

| | |
|---|---|
| Injection Pump | PFR Type |
| Plunger Diameter | φ5.5 |
| Injection Pipe | φ2-370 |
| Injection Nozzle | φ0.22 × 4 |
| Nozzle Open Press. | 19.5 MPa |

FIG. 2 illustrates the test bench configuration. The intake in the engine E is through an air filter 1 and a surge tank 2, and the predetermined fuel is supplied to the engine E from a fuel tank 5. The fuel supply amount in this case is measured with a burette 4. A pressure detector 3 that detects pressure inside cylinders, a thermometer 6 that detects an exhaust gas temperature, and a crank angle detector 7 are mounted on the engine E. Further, a dynamometer 8 is mounted on the output shaft of the engine E to measure the engine output. The output value of the pressure detector 3 is inputted to a data analyzer 12 through a strain gauge amplifier 11, and the output value of the crank angle detector 7 is also inputted to the data analyzer 12.

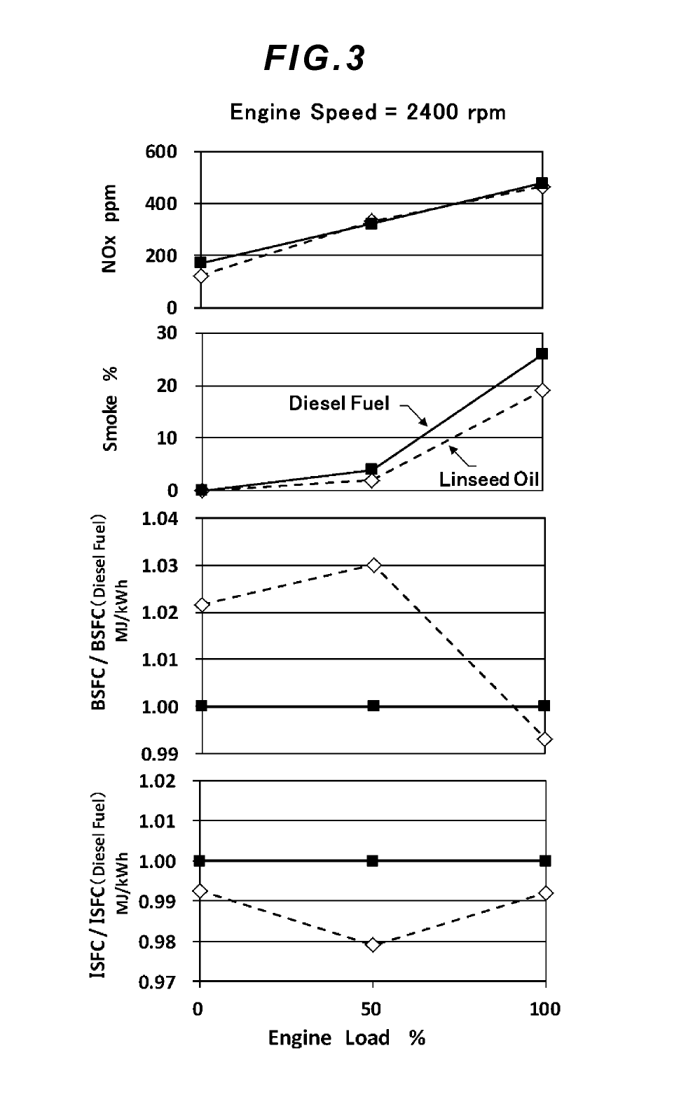

FIG. 3 illustrates how values of NOx, smoke concentration, BSFC, and indicated specific fuel consumption ISFC depend on the engine load (%) for linseed oil and the usual diesel oil. In the figure, broken and solid lines represent the properties obtained with linseed oil and the usual diesel oil, respectively. It follows from the figure that the BSFC is larger with linseed oil than with the usual diesel oil, and the ISFC is larger with the usual diesel oil than with the linseed oil. A high BSFC of neat biofuel (linseed oil) has been attributed to the degradation of mist forming ability of the fuel caused by a high viscosity. However, the neat biofuel has a low ISFC, which is due to a high combustion rate resulting from the neat biofuel being an oxygen-containing fuel. Another advantageous result is that smoke concentration is thus decreased.

Where linseed oil is used as the fuel, the BSFC is high and the ISFC is low. The above-described results suggest that where linseed oil is used, the friction loss in the engine increases due to a high viscosity. This supposition has been confirmed by the below-described test.

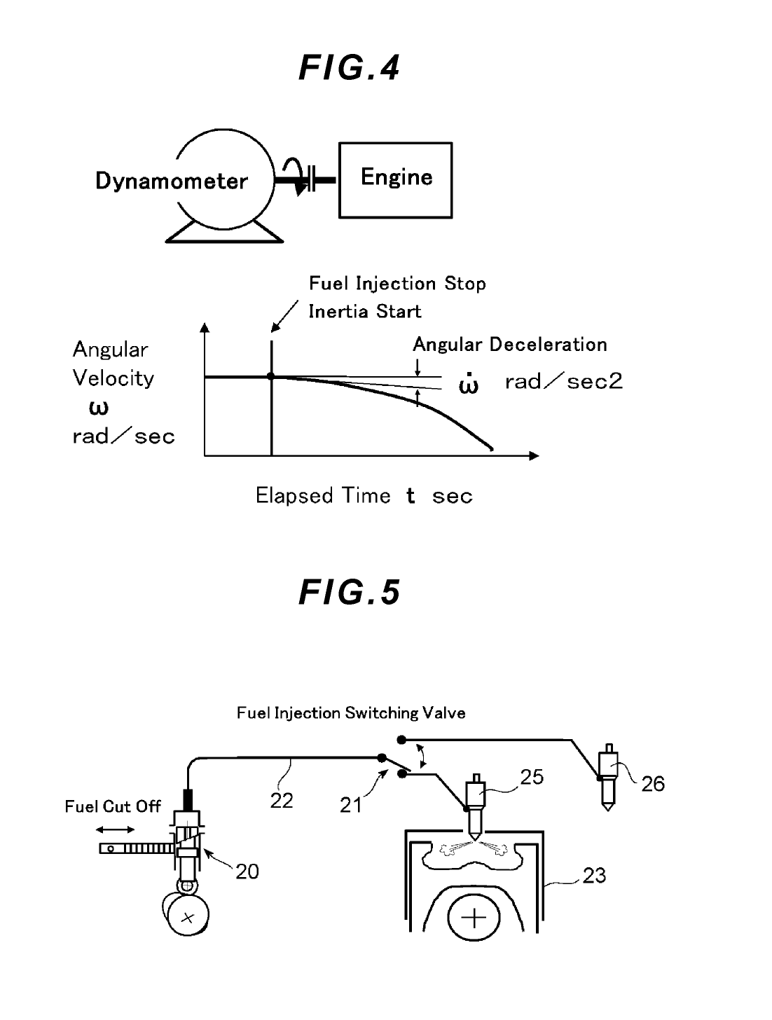

The deceleration method was used to measure the friction loss in the engine. With this method, as depicted in FIG. 4, the friction loss is measured on the basis of the relationship between the no-combustion deceleration of the engine and the friction torque corresponding to the engine speed and load immediately before the no-combustion and the deceleration is started. The friction loss or friction torque in the engine, which is defined herein, has a broad meaning including not only a mechanical loss, but also a pumping loss in the intake-exhaust strokes.

When the fuel is cut off and the engine has only the engine friction torque Tf and decelerates at the angular deceleration dω/dt, as depicted in FIG. 4, the relationship represented by Expression (2) hereinbelow is valid.

Tf=It×dω/dt (2)

Here, It is a total inertia momentum of the engine including the dynamometer 8 and a coupling member connected to the engine. The It can be determined by calculations on the basis of the engine specifications, but in this case, the It was determined experimentally in the following manner.

Where the angular deceleration at the time of deceleration occurring when the fuel supply to the engine is stopped while a load “ΔT” is applied to the dynamometer 8 is denoted by dω/dt(d), the engine deceleration relationship is represented by the following Expression (3). Further, the It can be determined from the Expressions (2) and (3) by the following Expression (4).

(Tf+ΔT)=It×dω/dt(d) (3)

It=ΔT/(dω/dt(d)−dω/dt) (4)

As follows from Expression (4), the It is determined by setting, as appropriate, the load ΔT to be applied by the dynamometer 8 and measuring the deceleration. The test results were rather stable, and in the present device, the It was 0.354 kgm². Based on these results, the engine friction loss or friction torque was experimentally determined from Expression (2) when linseed oil was used as the fuel and when the usual diesel fuel was used.

Initially, the engine friction loss was determined by a deceleration method A which is the first method. The test device configuration based on the deceleration method A is depicted in FIG. 5. The device using the deceleration method A includes a fuel supplying device 20 which is driven by the engine E and supplies the fuel to a fuel injection pipe 22 and an engine cylinder 23, and a switching valve 21 provided in the fuel injection pipe 22. The fuel supplying device 20 is configured to be switchable between a supply state in which the fuel is supplied to the fuel injection pipe 22 and a stop state in which the supply of the fuel to the fuel injection pipe 22 is stopped. The switching valve 21 serves to switch the supply of fuel between a fuel injection nozzle 25 which injects the fuel into the engine cylinder 23 and a fuel injection nozzle 26 which injects the fuel to the outside. As a result, the engine friction loss can be measured without fuel injection and while performing fuel injection. A driving torque for fuel injection is determined from the difference between the two results.

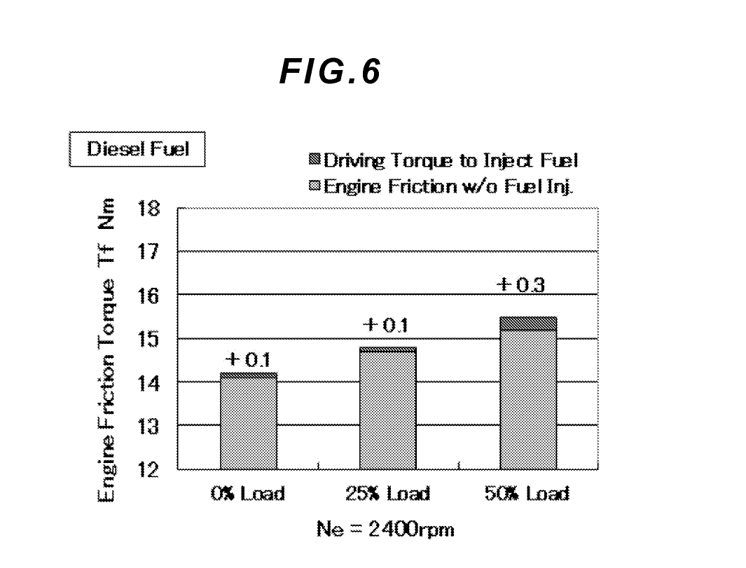

FIG. 6 shows the results of determining the engine friction loss and the driving torque for fuel injection for three types of engine load (0%, 25%, and 50%). The driving torque for fuel injection with the usual diesel fuel is 0.1 to 0.3 Nm correspondingly to the engine load. In the usual fuel injection system, about 1% of the maximum engine torque is typically the driving torque for fuel injection, and the maximum torque of the present engine is 19.6 Nm, as depicted in Table 2. The fuel injection driving torque of 0.1 to 0.3 Nm which has been measured by the deceleration method A is about 0.5 to 1.5% of the maximum torque, which can be considered as an adequate measurement result.

However, where the switching valve 21 is thus provided and the additional fuel supply pipe is provided, the wasted volume is increased which apparently results in the decrease in the fuel injection pressure. Since the fuel injection driving torque changes under the effect of the fuel injection pressure, the measurement results are apparently affected thereby. For this reason, the friction loss in the engine was measured by the below-described deceleration method B which is the second method.

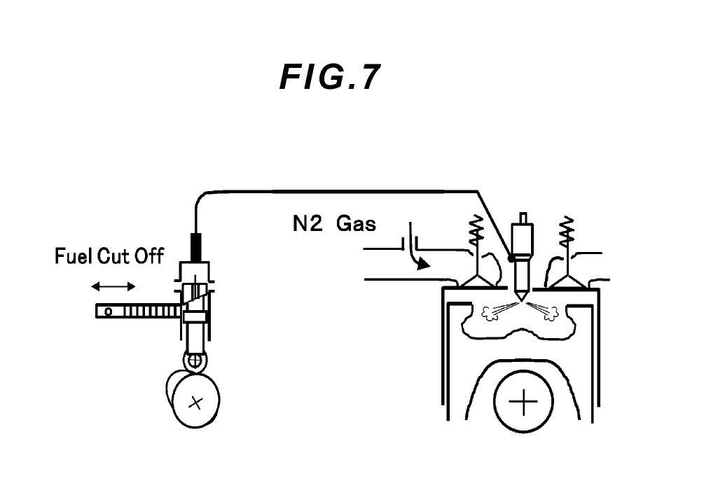

FIG. 7 shows the device configuration using the deceleration method B. In this device, nitrogen N₂ gas is supplied into the engine intake passage and the combustion inside the engine cylinder is suppressed while performing fuel injection. The resultant advantage is that the engine friction loss can be measured by switching from the engine performance testing state to the engine friction loss measuring state, without changing the engine operation state. The engine performance testing state and engine friction loss measuring state respectively correspond to the “driving state” and “measuring state” in the claims.

The measurement of the engine friction loss in this case is specifically explained hereinbelow. Initially, the fuel supplied by the fuel supplying device into the engine cylinder is burned and the engine is set to the driving state (performance testing state). From this state, the nitrogen N₂ gas is supplied into the engine cylinder while continuing the supply of fuel into the engine cylinder, the combustion of fuel in the engine cylinder is suppressed, and the engine is decelerated (the friction loss measuring state is assumed). Here, the angular deceleration dω/dt is measured at the time when the suppression of fuel combustion inside the engine cylinder is started by the supply of the nitrogen N₂ gas. The engine friction torque Tf is then determined by using Expression (2) from the calculated angular deceleration dω/dt and the total inertia momentum It of the engine which has been determined experimentally in advance and stored. The angular deceleration dω/dt may be calculated on the basis of a state in the course of deceleration after switching to the friction loss measuring state, instead of by calculations on the basis of the state at the time of switching from the performance testing state to the friction loss measuring state. It is also possible to calculate the angular deceleration dω/dt at a plurality of timings after switching to the friction loss measuring state and to average the calculated values.

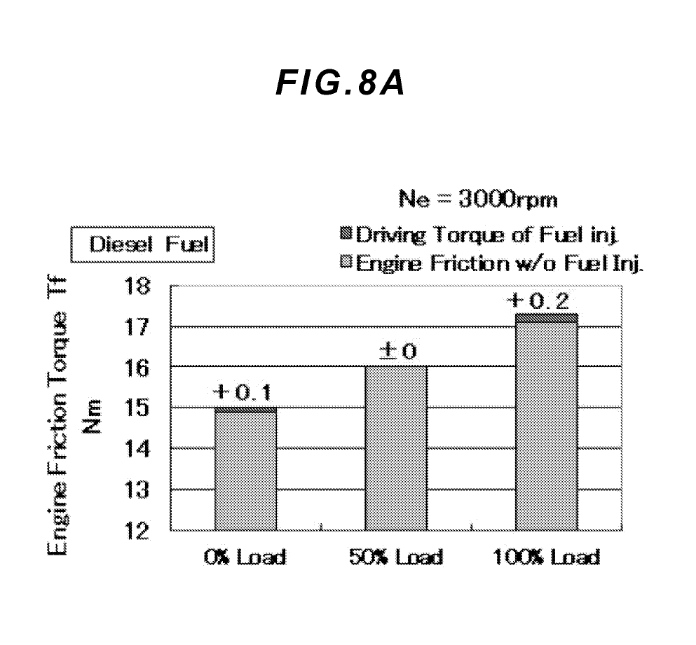

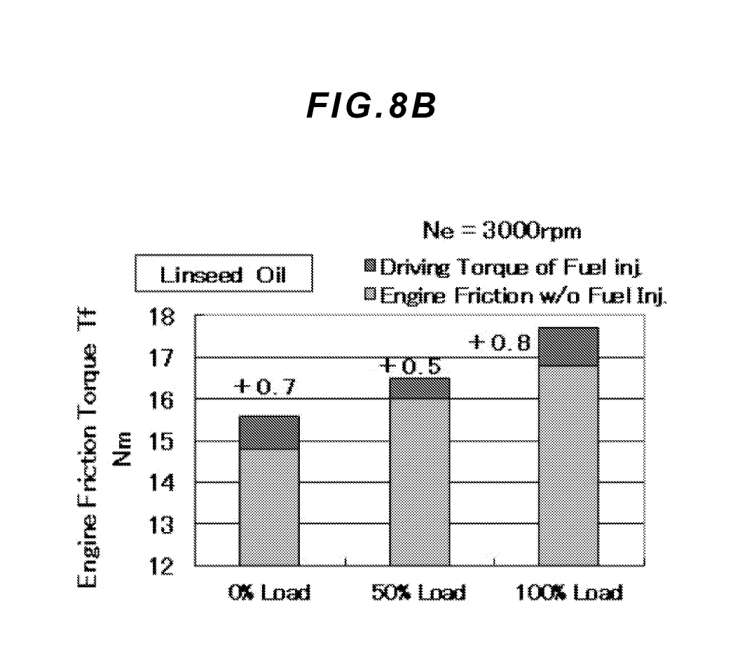

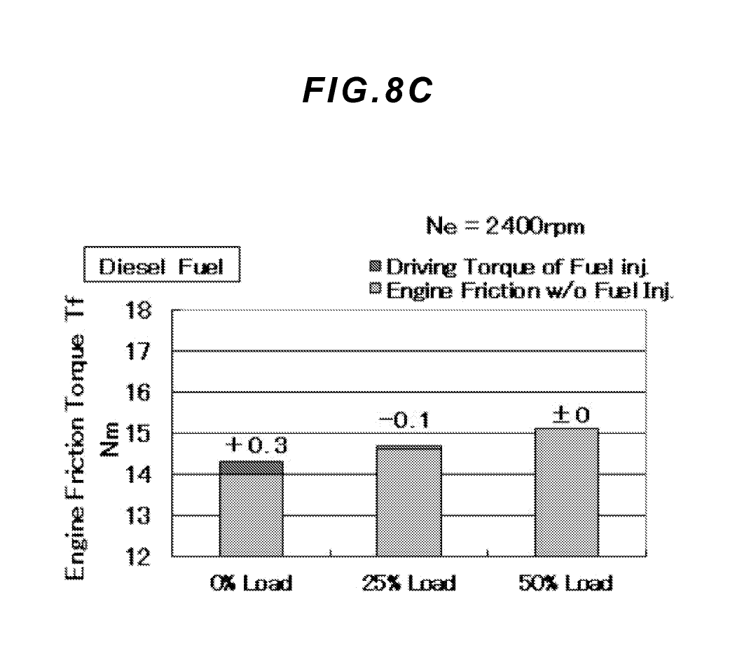

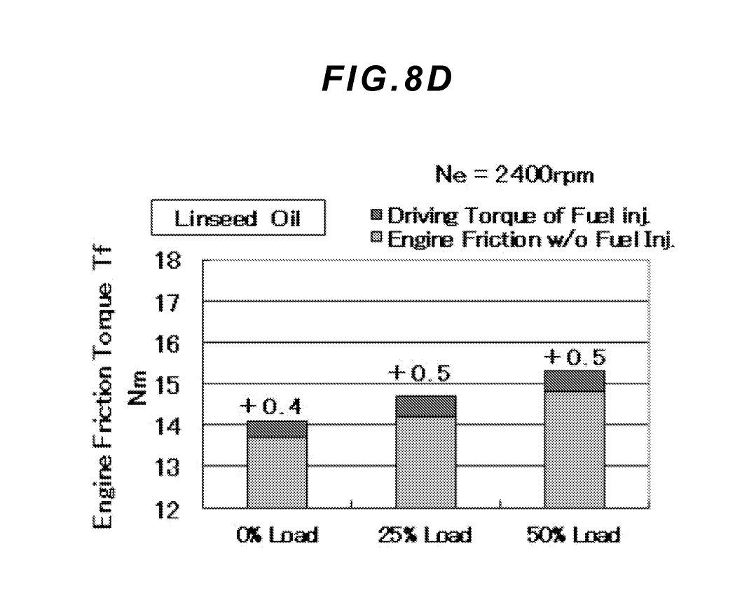

FIG. 8 shows the results obtained by measurements with the deceleration method B. FIGS. 8A and 8B show the measurement results relating to the engine friction torque and fuel injection driving torque at 3000 rpm. In the case of the usual diesel fuel (light oil), the fuel injection driving torque is as small as 0 to 0.2 Nm, whereas in the case of linseed oil, the fuel injection driving torque has a large value of 0.5 to 0.8 Nm. FIGS. 8C and 8D show the measurement results obtained at 2400 rpm, but demonstrate the same trend.

When the usual diesel fuel (light oil) is used, the fuel injection torque is such that it can substantially be ignored, but when linseed oil is used, since the viscosity thereof is high, it is clear that the fuel injection torque increases. Thus, it is clear that the fuel consumption rate BSFC is increased as a result of the increase in the fuel injection torque occurring when linseed oil is used.

The deceleration method B is explained hereinabove. The deceleration method illustrated by FIG. 4 is basically a method for measuring the engine friction torque by suppressing combustion inside the engine cylinder 23 to produce a state in which no work is performed by fuel combustion, and measuring the engine deceleration process in this state. However, actually, even when the fuel injection to the engine cylinder 23 is stopped, the supply of nitrogen N₂ gas is performed, and combustion is suppressed, the fuel that has adhered to the wall surface inside the engine cylinder 23 can slightly burn (this is referred to hereinbelow as “post-combustion dripping”). Where such post-combustion dripping occurs and a work is performed, the angular deceleration decreases accordingly. Therefore, an engine friction torque reduced correspondingly to the post-combustion dripping is actually measured. As a result, the accurate engine friction torque is difficult to obtain.

Accordingly, with the below-described deceleration method C, the quantity W of work performed by the post-combustion dripping is initially calculated. Then, a friction torque correction quantity ΔTf corresponding to the work quantity W is determined and added up to the measured friction torque Tf which is obtained by the actual measurements. The accurate corrected friction torque Tf* (engine friction torque) in which the post-combustion dripping is taken into account is thus calculated. This deceleration method C is described below in greater detail.

FIG. 7 shows the device configuration using the deceleration method C. In this device, the switching from the engine performance testing state to the engine friction loss measuring state is performed by stopping the supply of fuel by the fuel supplying device to the engine cylinder, and no nitrogen N₂ gas is, as a rule, supplied into the engine cylinder at this time. Even when the fuel supply is thus stopped, post-combustion dripping can occur. Accordingly, the calculation of the quantity W of work performed by the post-combustion dripping from the relationship between the cylinder pressure obtained with the pressure detector 3 and the cylinder volume corresponding thereto is investigated. In the deceleration method C, it is also possible to combine the supply of the nitrogen N₂ gas into the engine cylinder with the termination of fuel supply by the fuel supplying device to the engine cylinder at the time of switching to the engine friction loss measuring state, but even in this case, the post-combustion dripping can occur.

Since it is generally necessary to use the pressure detector 3 that can detect the maximum cylinder pressure, even though a comparatively high cylinder pressure can be detected with good accuracy, a comparatively low cylinder pressure is difficult to detect with good accuracy. Therefore, the cylinder pressure obtained with the pressure detector 3 easily becomes unstable, in particular, in a low-pressure region. As a result, the quantity W of work performed by the post-combustion dripping is difficult to calculate accurately as a surface area surrounded by a line representing the relationship between the cylinder volume and cylinder pressure.

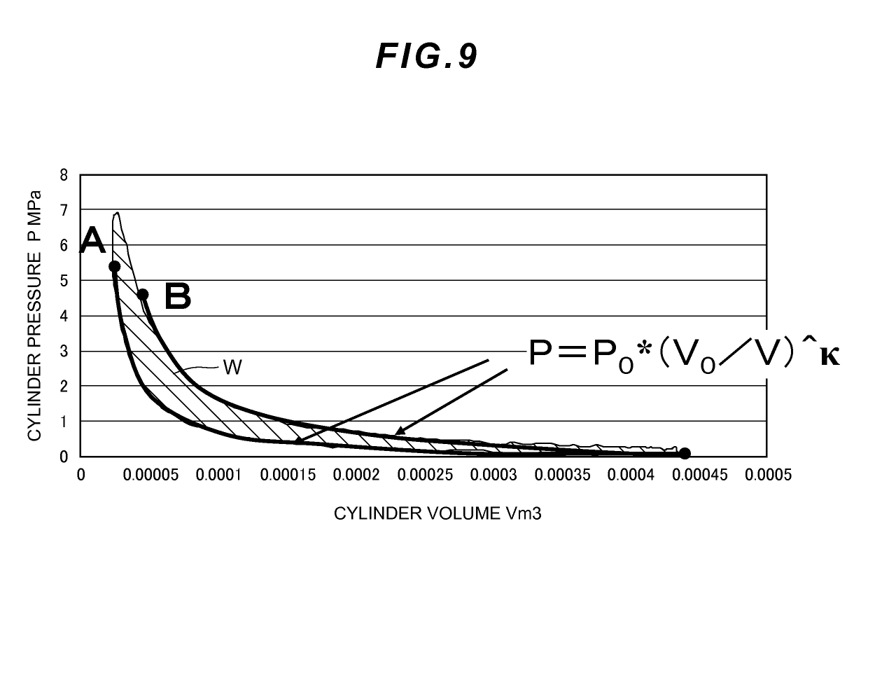

As indicated in FIG. 9, the post-combustion dripping continues to a comparatively high-pressure region (end point B) of an expansion stroke after being generated in a comparatively high-pressure region (start point A) of a compression stroke. Accordingly, in the deceleration method C, when a graph representing the relationship between the cylinder volume and cylinder pressure after switching to the engine friction loss measuring state, such as depicted in FIG. 9, is plotted, the cylinder pressure obtained by actual measurements with the pressure detector 3 is used with respect to a line of a high-pressure region from the start point A in which the post-combustion dripping has occurred to the end point B.

The start point A and end point B of the post-combustion dripping are specified on the basis of a polytropic index κ for each crank angle, which is obtained with Expression (5) below by using the cylinder pressure and cylinder volume.

(dP/P)/(dV/V)=−κ (5)

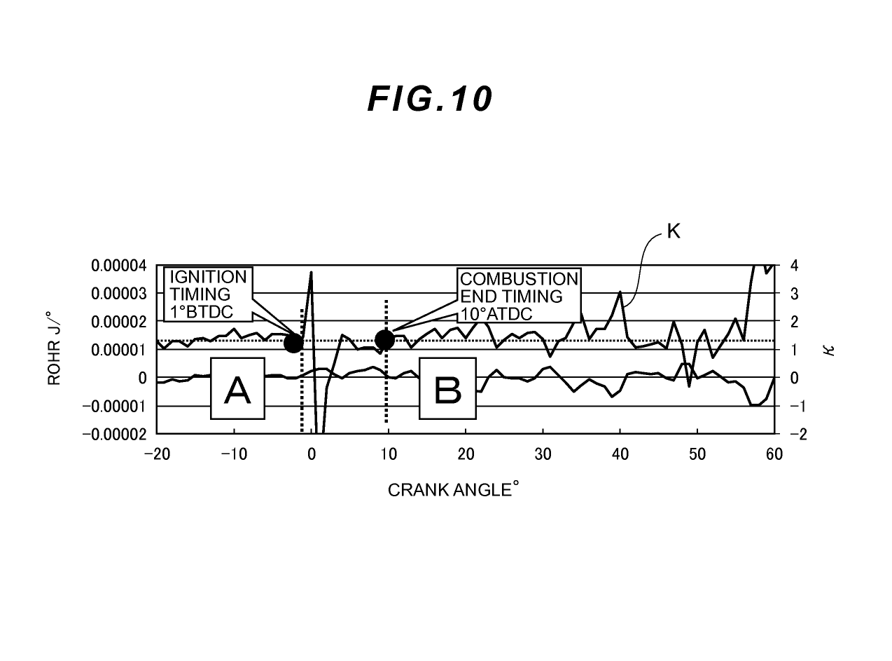

FIG. 10 depicts an example of the relationship between the polytropic index κ determined with Expression (5) above and the crank angle. The polytropic index κ is known to be stable close to 1.4 in a state in which no combustion is generated inside the engine cylinder 23, but to depart from the vicinity of 1.4 when combustion is started. Therefore, in the example depicted in FIG. 10, the crank angle 1° BTDC at which the polytropic index κ rapidly rises from the vicinity of 1.4 can be specified as the start point A of post-combustion dripping. In the stroke after the start point A, the polytropic index κ is approximated by a smooth curve, and a point where the straight line of the polytropic index κ=1.4 crosses this approximation curve can be specified as the end point B of post-combustion dripping. In the example depicted in FIG. 10, the crank angle 10° ATDC is specified as the end point B.

Meanwhile, since no combustion occurs in the comparatively low-pressure compression stroke and expansion stroke represented by a line outside the range from the start point A to the end point B in FIG. 9, those strokes can be considered to be adiabatic compression and adiabatic expansion. Therefore, the adiabatic compression curve passing through the start point A of post-combustion dripping in FIG. 9 can be determined by Expression (6) below.

P=P_{A}×(V_{A}/V)̂κ (6)

Here, P_{A} is the cylinder pressure in the start point A, V_{A} is the cylinder volume in the start point A, and κ is the polytropic index. Here, κ=1.4 because the process under consideration corresponds to the adiabatic change of air.

In FIG. 9, the adiabatic expansion curve passing through the end point B of post-combustion dripping can be determined by Expression (7) below.

P=P_{B}×(V_{B}/V)̂κ (7)

Here, P_{B} is the cylinder pressure in the end point B, and V_{B} is the cylinder volume in the end point B.

A graph is thus determined which represents the relationship between the cylinder volume and cylinder pressure such as depicted in FIG. 9. Theoretically, in a state in which no combustion is performed inside the engine cylinder 23, the surface area of the region surrounded by the line in the graph, that is, the work quantity W, is zero. However, actually, since the post-combustion dripping has occurred, the work quantity W corresponding thereto is represented as the surface area of the hatched portion.

Accordingly, where the work correction quantity ΔW is taken as W to be used for correcting the work quantity W, the relationship between the work correction quantity ΔW and the friction average effective pressure correction quantity ΔPmf is defined by Expression (8) below.

ΔW=ΔPmf×Vh (8)

In Expression (8), Vh is the exhaust amount of the engine E. The relationship between the friction average effective pressure correction quantity ΔPmf and the friction torque correction quantity ΔTf is defined by Expression (9) below.

ΔPmf=4π×(ΔTf/Vh) (9)

Therefore, where the work correction quantity ΔW is determined, the friction average effective pressure correction quantity ΔPmf is found from Expression (8) above. The friction torque correction quantity ΔTf is found from the friction average effective pressure correction quantity ΔPmf and Expression (9) above. Where the friction torque correction quantity ΔTf is added to the measured friction torque Tf, the accurate corrected friction torque Tf* which takes into account the post-combustion dripping can be determined.

The engine E outputs the drive power by repeating the intake, compression, expansion, and exhaust strokes in the order of description, but the lines corresponding to the intake stroke and exhaust stroke are not depicted in FIG. 9. This is because the work performed in the intake stroke and exhaust stroke is not related to the post-combustion dripping, and this work is obviously not taken into account in calculation of the corrected friction torque Tf*.

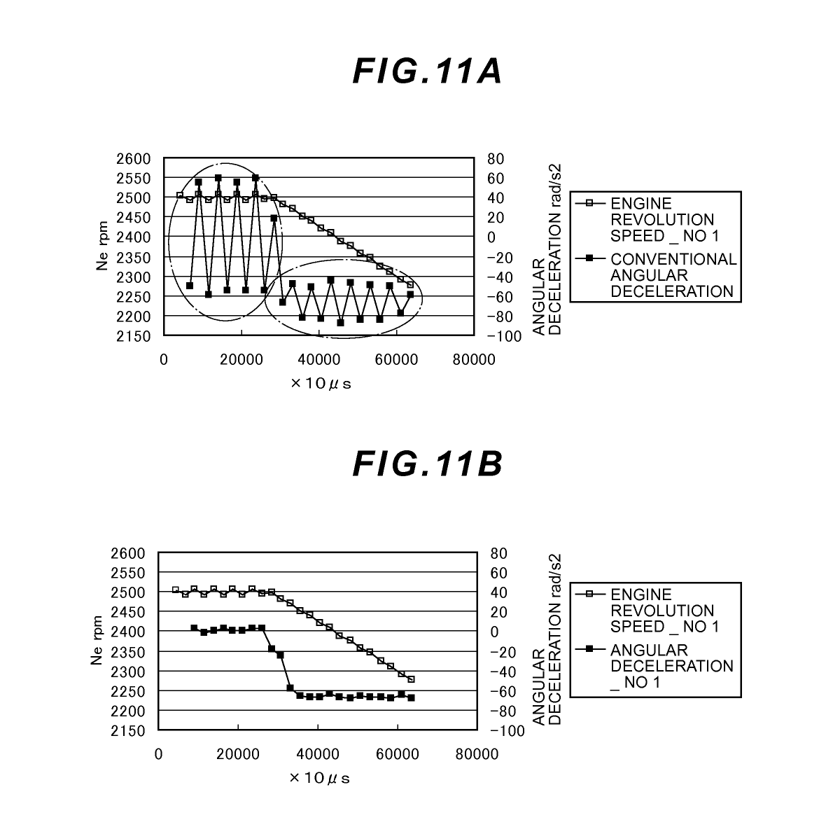

When the above-described deceleration methods A, B, and C are executed, it is preferred that the crank angle be detected by the crank angle detector 7 in the below-described manner. The crank angle detector 7 is configured of a slit scale (not depicted in the figures), which is provided with a slit at each predetermined angle (for example, 1°), and a light-emitting element and a light-receiving element (also not depicted in the figure) arranged to sandwich the slit scale. As indicated in Table 2, the engine used for this test is a four-cycle engine. Therefore, when the angular deceleration within an interval (one revolution) in which the crank shaft rotates through 360° is calculated, the adjacent angular decelerations vary significantly, as depicted in FIG. 11A. Accordingly, the adjacent angular decelerations are prevented from varying significantly and stabilized by calculating the angular deceleration for a 720°-rotation interval (two revolutions) of the crankshaft, as depicted in FIG. 11B. Therefore, the measurement accuracy of the friction loss measurement method performed using the angular deceleration is increased.

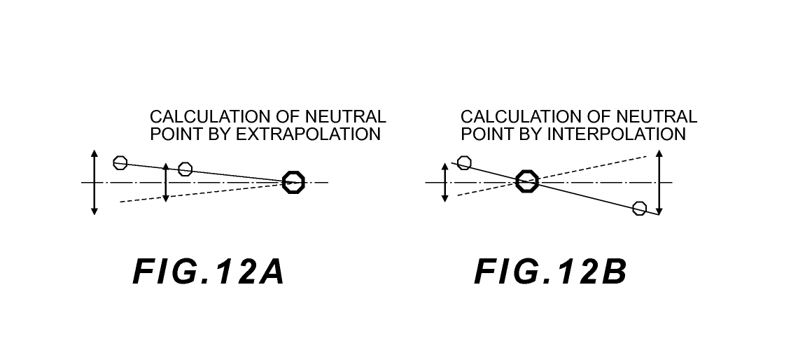

In the above-described deceleration methods A, B, and C, when the engine is decelerated by producing a state in which no combustion is generated inside the engine cylinder 23, torsional vibrations can occur in the crankshaft. Even when the angular deceleration is determined on the basis of the rotation angle of the torsionally vibrating portion, an accurate angular deceleration is difficult to obtain. Accordingly, slit scales are provided in a plurality of locations that differ from each other in the amplitude or phase of torsional vibrations. A neutral point in which no torsional vibrations occur is then determined by extrapolating (see FIG. 12A) or interpolating (see FIG. 12B) the crank angle signals obtained at the plurality of slit scales. The crank angle signal in the neutral point is then calculated and the angular deceleration is determined on the basis of the crank angle signal. As a result, it is possible to detect the accurate angular deceleration from which the effect of torsional vibrations generated in the crankshaft has been removed.

Instead of using the above-described deceleration method C, it is also possible to suppress the combustion by supplying nitrogen N₂ gas into the engine cylinder, while continuing the supply of fuel into the engine cylinder with the fuel supplying device, at the time of switching to the engine friction loss measuring state (this method is referred to hereinbelow as deceleration method D). Since the post-combustion dripping can also occur in the deceleration method D, the accurate corrected friction torque Tf* can be determined by calculating the quantity W of work performed by the post-combustion dripping, as described hereinabove. The driving torque for fuel injection can then be determined by finding the difference between the corrected friction torque Tf* calculated by the deceleration method D and the corrected friction torque Tf* calculated by the deceleration method C. Since the torque for fuel injection is typically only about several percent of the corrected friction torque Tf* calculated by the deceleration method D, this torque may be safely ignored.

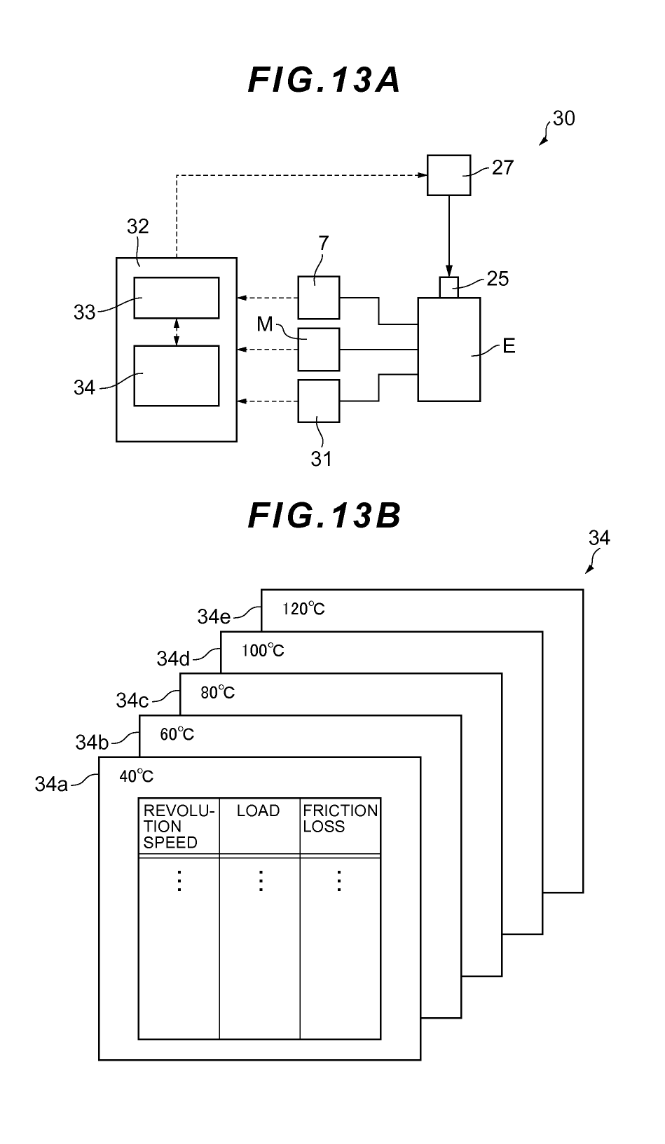

Methods for measuring the engine friction torque have been explained hereinabove. A method for detecting the driving state of an engine by using the method for measuring the engine friction torque will be explained hereinbelow with reference to FIG. 13. FIG. 13A is a block diagram of a driving state detection device 30 for detecting the driving state of the engine E. Initially the configuration of the driving state detection device 30 will be explained with reference to this figure.

The driving state detection device 30 is a device for detecting the driving state of the engine E when a driving object device M such as a generator, a hydraulic pump, or a ship propeller is driven by the engine E. The driving state detection device is configured of a crank angle detector 7, an oil temperature detector 31, and a controller 32. The crank angle detector 7 detects the revolution speed (rpm) of the engine E and outputs the detection signal corresponding to the detection result to the controller 32. The oil temperature detector 31 detects the lubricating oil temperature (° C.) of the engine E and outputs the detection signal corresponding to the detection result to the controller 32. For example, when the driving object device M is a generator, the load (Nm) of the engine E is detected on the basis of the power generation amount of the generator. The controller 32 is configured of a CPU 33 that performs computational processing and a memory 34 storing a program and data relating to fuel supply control of the engine E. The controller 32 outputs a command signal to the fuel supply pump 27, which is driven by the engine E, and performs control of switching between a supply state in which fuel is injected from the fuel injection nozzle 25 into the engine cylinder and a stop state in which the injection of fuel from the fuel injection nozzle 25 into the engine cylinder is stopped. The load (Nm) of the engine E can be also detected on the basis of the fuel injection quantity (fuel consumption) in the engine E.

FIG. 13B shows an example of data (normal state data 34a to 34e) that have been stored in advance in the memory 34 of the controller 32. In this example, the engine revolution speed (rpm), the engine load (Nm), and the friction loss corresponding to the engine revolution speed and engine load are stored for each lubricating oil temperature (40° C., 60° C., 80° C., 100° C., and 120° C.). The stored data represent actually measured values that have been obtained by driving the engine E in a state in which the engine E is normally driven, more specifically, a state in which the lubricating oil is normally circulated and there is no risk of the so-called “seizure”, and also a state in which the degradation of the lubricating oil has not advanced and the viscosity of the lubricating oil is low and a state in which sliding parts (bearings or the like) of the engine E are not abnormal. For example, the normal state data 34a corresponding to the lubricating oil temperature of 40° are obtained by changing the revolution speed and load of the engine E, while maintaining the lubricating oil temperature at 40° C., calculating the friction loss which takes into account the post-combustion dripping, and storing the calculated friction loss.

The fuel supply pump 27 of the engine E is switched by the controller 32 from the supply state to the stop state each time the predetermined time elapses since the drive has been started by the engine E, and then again returned to the supply state after a short-term stop state has been assumed in which the drive of the driving object device M is not inhibited. The controller 32 calculates the friction loss in the engine load state immediately preceding the stop state (friction loss taking into account the post-combustion dripping) by the above-described deceleration method C for each stop state. In this case, when any abnormality (poor circulation of the lubricating oil, degradation of the lubricating oil, abnormality associated with sliding parts, and the like) occurs in the engine E, a friction loss greatly exceeding the corresponding friction loss stored in the memory 34 is calculated, and when no abnormality occurs in the engine E, a friction loss close to the corresponding friction loss is calculated. Meanwhile, the controller 32 reads from the memory 34 the friction loss corresponding to the detection signals inputted at this time from the crank angle detector 7 and the oil temperature detector 31 and also to the detected engine load. The calculated friction loss is then compared with the corresponding friction loss that has been read from the memory 34.

Where the comparison result indicates that the calculated friction loss is larger than the corresponding friction loss, which has been read from the memory 34, the difference therebetween being equal to or greater than a predetermined value, it is determined that an abnormality (poor circulation of the lubricating oil, degradation of the lubricating oil, abnormality associated with sliding parts, and the like) has occurred in the engine E. The engine E can be prevented from damage by notifying of the occurrence of an abnormality in the engine E on the basis of this determination. Meanwhile, where the difference between the calculated friction loss and the corresponding friction loss, which has been read from the memory 34, is less than the predetermined value, it is determined that an abnormality inhibiting the drive has not occurred in the engine E.

However, since the engine typically operates cyclically, a fuel deposit (a residue constituted by incompletely burned fuel components and lubricating oil components) accumulates on the walls forming the cylinder space. Where fuel is injected into the cylinder space in which such fuel deposit has accumulated, part of the injected fuel is adsorbed by the fuel deposit and permeates thereinto. Therefore, where a large amount of fuel deposit accumulates on the walls of the cylinder space, a correspondingly large amount of injected fuel is adsorbed by the fuel deposit. As a result, the amount of fuel burning during the post-combustion dripping increases and the quantity of work performed by the post-combustion dripping increases. Therefore, the deposition state of the combustion deposit inside the cylinder space can be estimated on the basis of the quantity of work performed by the post-combustion dripping which is determined when calculating the friction loss in the above-described driving state detection device 30. Further, the combustion deposit accumulating inside the cylinder space can cause piston seizure, or the like. Therefore, for example, when a work quantity equal to or greater than a predetermined quantity is calculated as the quantity of work performed by the post-combustion dripping, piston seizure, or the like, can be reliably prevented by issuing a request to disassemble and clean the engine.

In the above-described embodiments, an example is explained in which nitrogen N₂ gas is used as an inflammable gas for suppressing the combustion, but other gases, for example, carbon dioxide gas, helium gas, and argon gas can be also used.

### EXPLANATION OF NUMERALS AND CHARACTERS

E (engine)
Tf (measured friction torque (friction torque)
ΔW work correction quantity (work)
ΔTf friction torque correction quantity (correction torque)

1. A method to measure a friction loss in an engine,
the engine being equipped with a fuel supplying device that is driven by the engine and performs fuel supply into an engine cylinder space,
the method comprising:
measuring an angular deceleration (dω/dt) of an output shaft after switching from a driving state, in which the engine is driven by burning fuel supplied by the fuel supplying device into the engine cylinder space, to a measuring state, in which deceleration is caused by suppressing the combustion of fuel in the engine cylinder space, and determining a friction loss in the engine on the basis of
a friction torque Tf of the engine which is found by Expression
Tf=It×dω/dt,
when It is a moment of inertia for an entire drive system of the engine, and
a correction torque corresponding to a work performed by post-combustion dripping generated in the engine cylinder space after switching from the driving state to the measuring state.

2. The method to measure a friction loss in an engine according to claim 1, wherein
the work performed by the post-combustion dripping is calculated on the basis of a surface area of a region bounded by a line indicating a relationship between a pressure and a volume of the engine cylinder space after switching from the driving state to the measuring state;
a measurement result relating to the pressure corresponding to the volume of the engine cylinder space is used for a portion of the line when the post-combustion dripping has occurred; and
a theoretical expression indicating an adiabatic change is used for a portion of the line other than the portion of the line when the post-combustion dripping has occurred.

3. The method to measure a friction loss in an engine according to claim 1, wherein
switching from the driving state to the measuring state is performed by stopping the supply of fuel to the engine cylinder space performed by the fuel supplying device.

4. The method to measure a friction loss in an engine according to claim 1, wherein
switching from the driving state to the measuring state is performed by supplying a non-flammable gas into the engine cylinder space while continuing the supply of fuel to the engine cylinder space performed by the fuel supplying device.

5. A method to detect an engine driving state,
the engine being equipped with a fuel supplying device that is driven by the engine and performs fuel supply into an engine cylinder space,
the method comprising:
a friction loss calculation step for measuring an angular deceleration (dω/dt) of an output shaft after switching from a driving state, in which the engine is driven by burning fuel supplied by the fuel supplying device into the engine cylinder space, to a measuring state, in which deceleration is caused by suppressing the combustion of fuel in the engine cylinder space, and determining a friction loss in the engine on the basis of
a friction torque Tf of the engine which is found by Expression
Tf=It×dω/dt,
when It is a moment of inertia for an entire drive system of the engine, and
a correction torque corresponding to a work performed by post-combustion dripping generated in the engine cylinder space after switching from the driving state to the measuring state;
a friction loss comparison step for comparing the calculated friction loss in the engine with a friction loss measured when the engine is driven in a normal state; and
a driving state detection step for detecting the driving state of the engine on the basis of the comparison result.
